(19) United States
(12) Patent Application Publication
(10) Pub. No.: US 2014/0305531 A1
(43) Pub. Date: Oct. 16, 2014

(54) FLEXIBLE PIPE

(71) Applicant: Wellstream International Limited, Newcastle-upon-Tyne, Tyne and W (GB)

(72) Inventor: Geoffrey Stephen Graham, Newcastle-upon-Tyne (GB)

(73) Assignee: WELLSTREAM INTERNATIONAL LIMITED, Newcastle-upon-Tyne, Tyne and Wear (GB)

(21) Appl. No.: 14/365,977

(22) PCT Filed: Dec. 13, 2012
(86) PCT No.: PCT/GB2012/053115

§ 371 Date: Jun. 16, 2014

(30) Foreign Application Priority Data
Dec. 23, 2011 (GB) 1122319.5

(51) Int. Cl. F16L 11/04

(52) U.S. Cl. CPC F16L 11/045
USPC 138/125; 138/138

(57) ABSTRACT

A flexible pipe body for transporting production fluids containing one or more acidic components comprises a fluid-retaining inner polymeric barrier layer and at least one layer including a metallic component and arranged outside said barrier layer, wherein said polymeric barrier layer comprises a first, inner, sub-layer of a polymeric barrier material through which at least some of said acidic component may permeate and a second sub-layer formed on said first sub-layer including a material capable of reacting chemically with said acidic component to form reaction products which are non-corrosive to said metallic component.

### INTRODUCTION

The present invention relates to flexible pipe configured for conveying production fluids, in particular oil and gas. More especially, the present invention relates to such flexible pipe configured for the conveyance of production fluids where the flexible pipe is, in use, located in a marine environment, more especially a subsea environment. The present invention relates in particular to flexible pipe for the conveyance of production fluids wherein the flexible pipe is configured for enhanced resistance to corrosive components of the production fluid.

### BACKGROUND

Flexible pipe for conveying production fluids is, per se, well known. A principal use of flexible pipe is in subsea environments where flexible pipe may be used deep water (less than 3,300 feet, 1005 metres) and/or ultra deep water (greater than 3,300 feet) applications for conveying production fluids. In these circumstances, flexible pipe is used for conveying large volumes of production fluids and may typically have an internal diameter of as much as 5 metres.

The use of flexible pipe in such demanding conditions imposes numerous design constraints. Notably, the flexible pipe must be able to withstand external pressure from water at depth, and also internal pressure of the fluid being conveyed. The flexible pipe must also be able to withstand tensile loads from its own self-weight and internal pressure cap end load. Furthermore, the flexible pipe must have a service life without any failure of several years, for example 20 or 25 years.

Flexible pipe is conventionally formed as an assembly of flexible pipe body and one or more end fittings. The pipe body is typically formed as a combination of layered materials which define a pressure-retaining conduit for the passage of production fluid.

The flexible pipe structure allows large deflection in the pipe without causing bending stresses which would impair the functionality of the pipe body during its service lifetime. The pipe body is typically built up as a combined structure including metallic layers and polymer layers. Generally, the metallic layers are provided for tensile strength and internal and external pressure resistance while the polymer layers are provided to prevent one or both of fluid ingress (i.e. water penetration) and production fluid egress from the bore of the flexible pipe.

A problem which occurs in conveying production fluids such as oil and gas is the presence in the production fluids of chemical components which are, at least potentially, corrosive or otherwise damaging to components of the flexible pipe body, in particular the metallic components. Amongst the potentially corrosive chemical components, hydrogen sulphide (H₂S) and carbon dioxide (CO₂) are particularly problematic. Clearly, corrosion of the metallic parts of the flexible pipe body will potentially shorten the service life of the flexible pipe and may possibly lead to failure of the flexible pipe and must therefore be either avoided or maintained within acceptable limits which do not prejudice safety.

Flexible pipe body is, of course, constructed to be fluid tight with respect to the production fluid being conveyed, and typically polymeric materials are used to provide this property. However, conventionally used polymeric materials are not wholly impervious to components of the production fluid, including corrosive components. This is particularly so where the corrosive components are small molecules such H₂S and CO₂ which can permeate the polymeric material. Thus, over the course of the service life of the flexible pipe body, corrosive substances can pass through the polymeric material layer or layers and come into contact with metallic components, leading to corrosion thereof.

Production fluids such as oil and gas are often categorised as either “sweet” or “sour” depending inter alia on the content of sulphur, which is associated with the content of H₂S. Fluids which are defined as “sour” typically have a sulphur content in excess of 0.5%. The higher H₂S content of sour production fluids renders them more corrosive. It follows that flexible pipe designed for use with “sweet” production fluid may not be suitable for use with “sour” production fluid as it may not have the necessary corrosion resistance. Flexible pipe body configured for use with sour production fluids will typically use higher grade (and therefore more expensive) steels for the metallic components, or may use a greater thickness of lower grade steels (as compared to the thickness required when conveying only sweet production fluids) which imposes a significant weight penalty which may limit the suitability of the flexible pipe body for certain applications, such as ultra deep applications. It is further noted that production fluids which are initially classified as sweet may turn sour during the service life of the flexible pipe.

It is an aim of the present invention to ameliorate or resolve the above described problems.

It is an aim of the present invention to incorporate means within the flexible pipe body which reduce or prevent the transmission of corrosive substances derived from the production fluid, so that contact of the corrosive substance with metallic components of the pipe body is reduced or eliminated.

It is an aim of the present invention to prevent or reduce the transmission of corrosive substances derived from production fluids to the metallic components of the flexible pipe body by incorporating in the flexible pipe body materials of substances which neutralise the corrosive substances, or which render them no longer corrosive or substantially less corrosive. Such materials or substances may have the effect of changing the chemical composition of the corrosive substances by causing a chemical reaction of the corrosive substances, or by undergoing a chemical reaction with the corrosive substances.

U.S. Pat. No. 6,110,550 describes pipe for production fluids, the pipe including a thermoplastic sheath layer. The sheath layer is doped with a chemical which reacts with H₂S permeating into the layer, to result in non-corrosive reaction products. Such chemicals include organic amines and oxides of lead, zinc, copper, cadmium, nickel, cobalt, tin and molybdenum.

US 2011/0120583 is a development of U.S. Pat. No. 6,110,550 and specifies that the chemical included to react with H₂S or CO₂ is in the form of particles having a specific surface area in excess of 5 m²g⁻¹.

### BRIEF SUMMARY OF THE DISCLOSURE

In accordance with the present invention there is provided a flexible pipe body for transporting production fluids containing one or more acidic components, the flexible pipe body comprising a fluid-retaining inner polymeric barrier layer and at least one layer including a metallic component and arranged outside said barrier layer, wherein said polymeric barrier layer comprises a first, inner, sub-layer of a polymeric barrier material through which at least some of said acidic component may permeate and a second sub-layer formed on said first sub-layer including a material capable of reacting chemically with said acidic component to form reaction products which are non-corrosive to said metallic component.

Preferably the flexible pipe body further comprises a third sub-layer, formed on said second sub-layer, and comprising a polymeric material.

In preferred embodiments said material capable of reacting with said acidic component is selected from PbO, ZnO, CuO, CdO, NiO, CoO, SnO₂, MoO₃, primary, secondary or tertiary amines, alkaline earth metal oxides, alkaline earth metal hydroxides, alkali metal oxides and alkali metal hydroxides.

Preferably the acidic component is H₂S and/or CO₂.

In some preferred embodiments the material capable of reacting with said acidic component is carried on a chemical support.

Preferably the chemical support is selected from a nanoparticle material and an activated charcoal.

Preferably the chemical support is a pulverulent material.

In other preferred embodiments the material capable of reacting with said acidic component is carried on a physical support, in particular a porous, reticulate, mesh, or woven support.

In some preferred embodiments said chemical support is carried on a porous, reticulate, mesh, or woven support.

Preferably said porous, reticulate, mesh, or woven support is a woven or non-woven fabric.

In preferred embodiments the support is in the form of an elongate web wound around said first sub-layer.

Preferably the second sub-layer is substantially longitudinally and circumferentially co-extensive with said first sub-layer.

Preferably the material capable of reacting chemically with said acidic component is substantially evenly distributed in said second sub-layer.

### BRIEF DESCRIPTION OF THE DRAWINGS

For a better understanding of the invention and to show how the same may be carried into effect, reference will be made, by way of example only, to the following drawings, in which

FIG. 1 is a sectional view of a typical flexible pipe body suitable for conveying production fluids;

FIG. 2 is a schematic view illustrating a typical arrangement of a flow line, riser and jumper employing flexible pipe body; and

FIG. 3 is a schematic cross section of a flexible pipe body according to the present invention;

### DETAILED DESCRIPTION

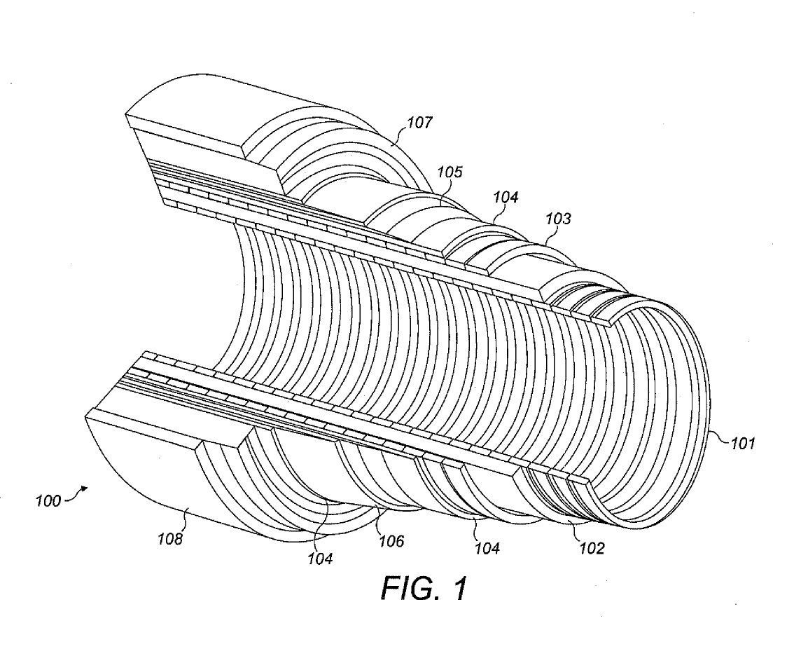

In the drawings like reference numerals refer to like parts. Throughout this description, reference will be made to a flexible pipe. It will be understood that a flexible pipe is an assembly of a portion of a pipe body and one or more end fittings in each of which a respective end of the pipe body is terminated. FIG. 1 illustrates a non-limiting example of how pipe body 100 is formed in accordance with an embodiment of the present invention from a combination of layered materials that form a pressure-containing conduit.

Although a number of particular layers are illustrated in FIG. 1, it is to be understood that the present invention is broadly applicable to coaxial pipe body structures including two or more layers manufactured from a variety of possible materials. It is to be further noted that the layer thicknesses are shown for illustrative purposes only.

As illustrated in FIG. 1, a pipe body 100 includes an optional innermost carcass layer 101 and an internal pressure sheath 102. The carcass layer 101 has an interlocked construction that can be used as the innermost layer to prevent, totally or partially, collapse of the internal pressure sheath 102 due to pipe decompression, external pressure, and tensile armour pressure and mechanical crushing loads. It will be appreciated that certain embodiments of the present invention are applicable to ‘smooth bore’ operations (i.e. without a carcass layer 101) as well as such ‘rough bore’ applications (with a carcass layer 101).

The internal pressure sheath 102 acts as a fluid retaining layer and comprises a polymer layer that ensures internal fluid integrity. Layer 102 may in particular embodiments comprise a number of sub-layers. The internal pressure sheath 102 is often referred to by those skilled in the art as a barrier layer. In operation without a carcass layer 101 (so-called smooth bore operation) the internal pressure sheath 102 may be referred to as a liner.

An optional pressure armour layer 103 is a structural layer with a lay angle close to 90° that increases the resistance of the flexible pipe to internal and external pressure and mechanical crushing loads. The pressure armour layer 103 also structurally supports the internal pressure sheath 102, and typically has an interlocked construction.

The flexible pipe body 100 may also include an optional first tensile armour layer 105 and an optional second tensile armour layer 106. Each tensile armour layer 105, 106 is a structural layer with a lay angle typically between 10° and 55°. Each tensile armour layer 105, 106 is used to sustain tensile loads and internal pressure. The tensile armour layers 105, 106 are often counter-wound in pairs.

The flexible pipe body 100 as shown also includes optional layers of tape 104 which help contain underlying layers and to some extent prevent abrasion between adjacent layers.

The flexible pipe body 100 also typically includes optional layers of insulation 107 and an outer sheath 108, which comprises a polymer layer used to protect the pipe against penetration of seawater and other components of the external environment, and against corrosion, abrasion and mechanical damage.

Each flexible pipe comprises at least one portion, sometimes referred to as a segment or section of pipe body 100 together with an end fitting located at at least one end of the flexible pipe. An end fitting provides a mechanical device which forms the transition between the flexible pipe body and a connector. The different pipe layers as shown, for example, in FIG. 1 are terminated in the end fitting in such a way as to transfer the load between the flexible pipe and the connector.

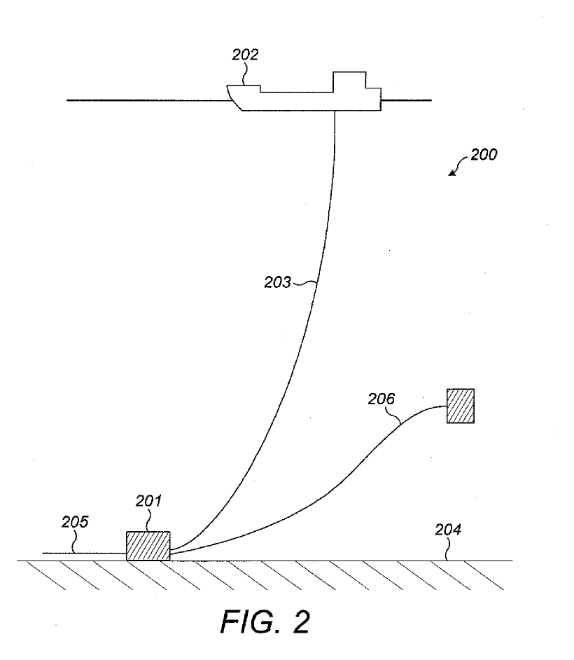

FIG. 2 illustrates a riser assembly 200 suitable for transporting production fluid such as oil and/or gas and/or water from a sub-sea location 201 to a floating facility 202.

For example, in FIG. 2 the sub-sea location 201 includes a sub-sea flow line 205. The flexible flow line 205 comprises a flexible pipe, wholly or in part, resting on the sea floor 204 or buried below the sea floor and used in a static application. The floating facility 202 may be provided by a platform and/or buoy or, as illustrated in FIG. 2, a ship. The riser assembly 200 is provided as a flexible riser, that is to say a flexible pipe 203 connecting the ship 202 to the sea floor installation 201. The flexible pipe 203 may be in segments of flexible pipe body with connecting end fittings.

It will be appreciated that there are different types of riser, as is well-known by those skilled in the art. Embodiments of the present invention may be used with any type of riser, such as a freely suspended (free, catenary riser), a riser restrained to some extent (buoys, chains), totally restrained riser or enclosed in a tube (I or J tubes).

FIG. 2 also illustrates how portions of flexible pipe can be utilised as a flow line 205 or jumper 206.

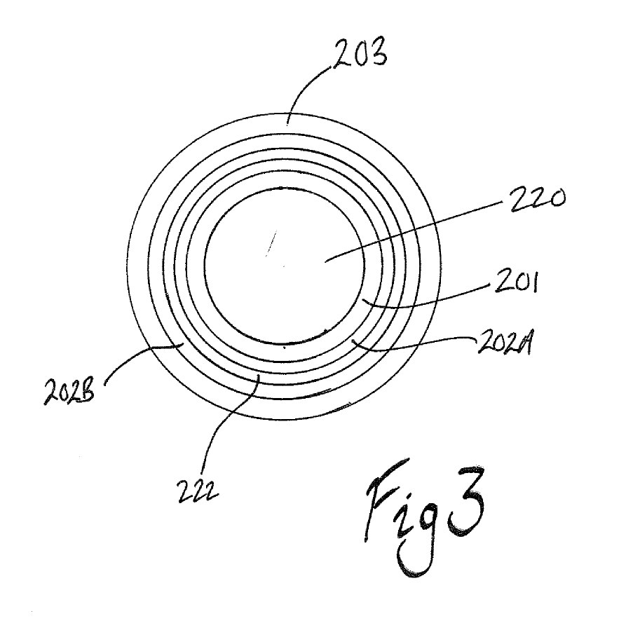

Referring now in particular to FIG. 3, there is shown a section through a flexible pipe body 200 according to the invention which comprises various layers. The layers are not shown to scale. Any of the layers 101, 103, 104, 105, 106, 107 and 108 as described in relation to FIG. 1 may be present in the flexible pipe body according to the invention, in accordance with particular design and use requirements which may be determined on a case by case basis by the person skilled in the art. However, for reasons of clarity, in FIG. 3 only the innermost layers of flexible pipe body 200 are illustrated.

The pipe body 200 illustrated in FIG. 3 defines a bore 220 in which production fluids are conveyed. The bore is fluid tight at the pressure and temperature of the production fluid which is conveyed and a polymeric barrier layer 202A, 202B is provided for this purpose. Within the barrier layer 202A, 202B an optional carcass layer 201 may be provided. Outside the barrier layer is a metallic material containing layer 203 which may typically be a pressure armour layer. Other layers as noted in relation to FIG. 1 may lie outside the layer 203.

The barrier layer 202A, 202B prevents production fluids from contacting metal containing layers (203) of the flexible pipe body 200 located radially outwardly of the barrier layer 202A, 202B. However, materials used for the barrier layer 202A, 202B are typically thermoplastic polymer materials which are typically permeable over time to small molecules. The rate of permeation is generally low, but can be significant over the long service life of a flexible pipe. Such small molecules can include chemical components which are corrosive to metals or metal containing layers of the flexible pipe body 200, notably acidic chemical components such as H₂S and CO₂.

In order to prevent, or at least mitigate, the corrosive effect of such acidic chemical components the present invention provides a material capable of reacting chemically with said acidic components to render them innocuous to the metal or metal containing layers (hereinafter “reactive material”).

Suitable materials capable of reacting chemically with said acidic components include PbO, ZnO, CuO, CdO, NiO, CoO, SnO₂, MoO₃, primary, secondary or tertiary amines, alkaline earth metal oxides, alkaline earth metal hydroxides, alkali metal oxides and alkali metal hydroxides. Particular examples of amines include monoethanolamine (MEA), diethanolamine (DEA), N-methyldiethanolamine (MDEA) and diisopropanolamine (DIPA).

The barrier layer 202A, 202B in the pipe body 200 according to the comprises at least an inner barrier sub-layer 202A, which may be the innermost layer of the pipe body 200, or which may lie outside an optional carcass layer 201. The reactive material is applied to an outer surface of the barrier sub-layer 202A. Most preferably the reactive material is applied uniformly over the entire radially outer surface of the barrier sub-layer 202A. The quantity of application of the reactive material to the barrier sub-layer 202A is determined in accordance with the service life and requirements of the pipe body 200. Specifically, the amount of reactive material which is used is selected to be sufficient to provide control of corrosion of metallic components lying radially outside the barrier layer 202A, 202B for the whole service life of the pipe body 200. The required amount of reactive material will depend on the intended length of the service life of the flexible pipe body 200, and the rate of permeation of acidic components through the barrier sub-layer 202A, which may in turn depend on the operating conditions of the flexible pipe body 200, such as the pressure and temperature of the production fluid within the bore 220 of the flexible pipe body 200 and, of course, the chemical composition of the production fluid. These are matters which are known or calculable by the person skilled in the art.

In particularly preferred arrangements, a further barrier sub-layer 202B is formed immediately radially outwardly of the reactive material 222. The barrier sub-layer is also preferably formed from a thermoplastic polymeric material. Thus, the barrier layer 202 has, in preferred embodiments, a sandwich construction comprising (in order from the radially innermost part to the radially outermost part) a barrier sub-layer 202A, the reactive material 222 on the outer surface of the barrier sub-layer 202A, and the second barrier sub-layer 202B encompassing the reactive material.

It is possible that the reactive material 222 may be coherent and self-supporting in which case it may be applied directly to the radially outer surface of the inner barrier sub-layer 202A.

However, in preferred constructions, the reactive material 222 is carried on a physical and/or chemical support.

The chemical support may preferably be in the form of a nano-particulate material or an activated charcoal or a porous material to which the reactive material is adhered, adsorbed or absorbed.

The physical support may preferably be a reticulate or mesh material which carries the reactive material. For example the reactive material may be coated on or impregnated into the physical support. The physical support may absorb the reactive material. In particularly preferred arrangements, the physical support is a web of woven or non-woven fabric which is coated or impregnated with the reactive material.

In variations, the reactive material may be carried on a chemical support and the combined reactive material-chemical support is in turn carried on a physical support such as those noted above.

In particularly preferred variations, the web of woven or non-woven fabric carrying the reactive material is in the form of an elongate tape which may be wound around the radially outer surface of the barrier sub-layer 202A. For example, the tape carrying the reactive material can be wound in a helical pattern.

In embodiments, the quantity of reactive material provided is determined by providing successive windings of said tape one upon the other until the desired amount of reactive material (in view of the required service life and use conditions of the flexible pipe body 200) is achieved.

The second barrier sub-layer 202B may be applied directly to the outer layer of tape.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments.

The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. A flexible pipe body for transporting production fluids containing one or more acidic components, the flexible pipe body comprising a fluid-retaining inner polymeric barrier layer and at least one layer including a metallic component and arranged outside said barrier layer, wherein said polymeric barrier layer comprises a first, inner, sub-layer of a polymeric barrier material through which at least some of said acidic component may permeate and a second sub-layer formed on said first sub-layer including a material capable of reacting chemically with said acidic component to form reaction products which are non-corrosive to said metallic component.

2. A flexible pipe body as claimed in claim 1 further comprising a third sub-layer, formed on said second sub-layer, and comprising a polymeric material.

3. A flexible pipe body as claimed in claim 1 wherein said material capable of reacting with said acidic component is selected from PbO, ZnO, CuO, CdO, NiO, CoO, SnO₂, MoO₃, primary, secondary or tertiary amines, alkaline earth metal oxides, alkaline earth metal hydroxides, alkali metal oxides and alkali metal hydroxides.

4. A flexible pipe body as claimed in claim 1 wherein the acidic component is H₂S and/or CO₂.

5. A flexible pipe body as claimed in claim 1 wherein the material capable of reacting with said acidic component is carried on a chemical support.

6. A flexible pipe body as claimed in claim 5 wherein the chemical support is selected from a nanoparticle material and an activated charcoal.

7. A flexible pipe body as claimed in claim 5 wherein the chemical support is a pulverulent material.

8. A flexible pipe body as claimed in claim 1 wherein the material capable of reacting with said acidic component is carried on a porous, reticulate, mesh, or woven support.

9. A flexible pipe body as claimed in claim 5 wherein said chemical support is carried on a porous, reticulate, mesh, or woven support.

10. A flexible pipe body as claimed in claim 8 wherein said porous, reticulate, mesh, or woven support is a woven or non-woven fabric.

11. A flexible pipe body as claimed in claim 8 wherein the support is in the form of an elongate web wound around said first sub-layer.

12. A flexible pipe body as claimed in claim 1 wherein the second sub-layer is substantially longitudinally and circumferentially co-extensive with said first sub-layer.

13. A flexible pipe body as claimed in claim 1 wherein the material capable of reacting chemically with said acidic component is substantially evenly distributed in said second sub-layer.

14.-15. (canceled)
